(19) United States
(12) Patent Application Publication
(10) Pub. No.: US 2026/0270055 A1
(43) Pub. Date: Sep. 10, 2026

(54) Entropy-as-Data for Secure Data Storage Systems

(71) Applicant: ORACLE INTERNATIONAL CORPORATION, Redwood Shores, CA (US)

(72) Inventor: Brian R. RAMOS, Blanden (BE)

(21) Appl. No.: 19/072,419

(22) Filed: Mar. 6, 2025

(51) Int. Cl. H04L 9/08; H04L 9/32

(52) U.S. Cl. CPC H04L 9/0866; H04L 9/0863; H04L 9/0869; H04L 9/32

(57) ABSTRACT

Systems, methods, and other embodiments associated with data security and encryption are described. In one embodiment, a method includes scanning a region of a data storage medium to detect physical characteristics (e.g., entropy) of the region in the data storage medium. A characteristics-based encryption key is generated based on at least the physical characteristics of the data storage medium. Data content stored on the data storage medium are then encrypted with the characteristics-based encryption key to create a location relationship between the data storage medium and the data contents.

### BACKGROUND

Data security is an important aspect of computing systems and cloud storage systems. Traditional cloud storage solutions rely on separate key management systems, which introduce vulnerabilities. Key compromise or theft can lead to widespread data breaches. One problem with standard encryption is that a user or other system cannot determine if the contents were copied, modified, moved, or tampered with.

Data encryption systems are crucial for protecting sensitive information, but they come with several technical problems and limitations. For example, key management requires securely generating, storing, distributing, and revoking encryption keys frequently. This involves a complex process with many steps. Managing encryption across large-scale cloud environments or distributed systems requires advanced key management and secure communications. Encrypting large volumes of data can introduce latency issues, especially in real-time applications.

Furthermore, if an encryption key is lost, the encrypted data may become permanently inaccessible. If a key is exposed, unauthorized users can decrypt sensitive information. Also, prior encryption and decryption systems require computational power, which can slow down system performance. Stronger encryption algorithms (e.g., AES-256) require more processing resources, which may not be ideal for low-power devices.

There is a need for a novel approach that may reduce or eliminate this vulnerability and complex key management process by intrinsically binding encryption keys to the physical storage media.

### SUMMARY

In one embodiment, a computing system is described that includes a data security system configured to encrypt/decrypt data based on physical characteristics/properties of a storage medium that contains the data. For example, the system may scan a region of a data storage medium to detect physical characteristics of the region in the data storage medium; generate a characteristics-based encryption key based on at least the physical characteristics of the physical storage medium; and encrypt data contents stored on the data storage medium with the characteristics-based encryption key.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be implemented as multiple elements or that multiple elements may be implemented as one element. In some embodiments, an element shown as an internal component of another element may be implemented as an external component and vice versa. Furthermore, elements may not be drawn to scale.

FIG. 1 illustrates one embodiment of a system associated with a secure data storage and security system that is associated with encryption based on physical characteristics of a data storage medium.

FIG. 2 illustrates one embodiment of a data security method associated with the data security system 100 to encrypt data based on physical characteristics of a storage medium.

FIG. 3 illustrates another embodiment of a method associated with generating a characteristics-based encryption key from FIG. 2 in a format of a salted password.

FIG. 4 illustrates another embodiment of the data security system 100 (from FIG. 1) and a method to control access to a storage medium.

FIG. 5 illustrates an embodiment of a computing system configured with the example systems and/or methods disclosed.

### DETAILED DESCRIPTION

Systems and methods are described herein that provide a data security system that implements encryption and decryption based on physical characteristics of a data storage medium. In one embodiment, the present data security system provides a novel technique that reduces or eliminates the security vulnerabilities of prior systems by intrinsically binding encryption keys to the physical storage media. For example, the present technology leverages the fact that even with advanced manufacturing, each optical disc possesses unique, microscopic imperfections within its protective resin layer, which creates unique entropy.

These imperfections, or otherwise the entropy of the medium, when scanned and analyzed, create a distinct, three-dimensional “fingerprint” for each disc that are unique physical characteristics/properties of a disc. The present system uses these physical characteristics, which may include physical defects, as data. For example, the unique physical characteristics are used to generate unique encryption/decryption keys to protect the data stored on the disc. Thus, the physical entropy/defects of a storage medium may be used as data input to an encryption key generator.

The present encryption technique creates a location relationship between the data storage medium (e.g., an original data source) and the data contents stored thereon. The encryption/decryption key can then be used to authenticate the data and its original data source, in one embodiment. The authentication will fail, for example, when the data is retrieved from a different data source, meaning the data has been moved and/or improperly copied (e.g., counterfeit) because the physical characteristics of the different data source will not generate the same original encryption/decryption key.

Several technical advantages and improvements are provided by the present system. For example, Intrinsic Key Binding is provided where encryption keys are derived from and inextricably linked to the unique physical characteristics of each optical disc or other data storage medium. Separate Key Storage may be eliminated as the present encryption keys do not need to be stored separately because they may be generated on-demand from the physical characteristics of the storage medium in response to a data access request. This eliminates the risk of key compromise or theft. Enhanced Data Protection may be provided as the stored data is inherently protected, as access to the stored data may be based on and/or requires both a correct password and the physical disc to generate a decryption key, in one embodiment.

In many prior security systems, using passwords is common. One technical problem with standard encryption is that a user or other system that is accessing some data using the correct password cannot know if the contents were copied, modified, moved, or tampered with.

In one embodiment, the present security system ensures that the contents are in its original media source since the data encryption is based on the physical characteristics of the original media source. If the contents are moved or copied to a different medium, verification will fail since the different media will have different physical characteristics, which in turn will not generate the same encryption/decryption key. Thus, using the scanning device and binding data contents to a source medium reduces counterfeiting.

### System Overview Embodiment

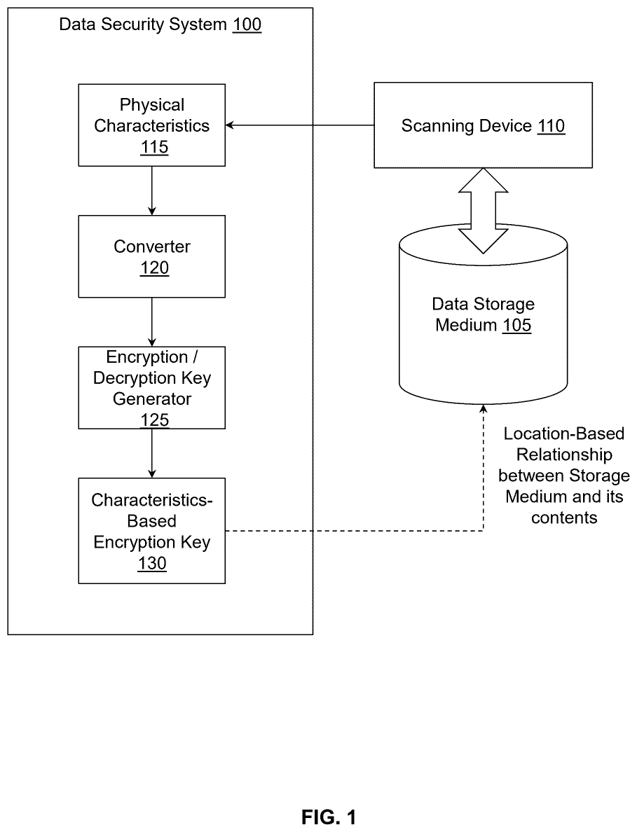

With reference to FIG. 1, one embodiment of a data security system 100 is illustrated that is associated with encryption based on physical characteristics of a data storage medium 105. In one embodiment, the data security system 100 may be implemented in or part of a computing system (e.g., a cloud-based server) that provides access to one or more cloud-based data storage systems (e.g., data storage medium 105). Cloud-based data storage systems may contain one or more different types of data storage media and/or combinations, for example, optical discs, magnetic storage, solid-state media, etc.

To secure the data contents on the data storage medium 105, the data security system 100 may control a scanning device 110 to scan a region of the data storage medium 105 to detect physical characteristics 115 (e.g., entropy) of the region in the data storage medium 105. Here, the data storage medium 105 is presumed to be an original storage source for the data stored thereon (e.g., a set of data content).

In one embodiment, the data security system 100 may select a target region to scan that will be used as a key-generation region. The same key-generation region is also used for decryption key generation, which is described below. As previously stated, the present system leverages the fact that even with advanced manufacturing, every data storage medium such as an optical disc possesses unique, microscopic imperfections. These imperfections, when scanned and analyzed, create a distinct set of physical characteristics 115 of the scanned region, which are uniquely associated with the specific data storage medium.

Example scanning devices 120 may include, but are not limited to, a surface profilometer or a scanning electron microscope (SEM), optical microscope, atomic force microscope (AFM), Scanning Acoustic Microscope (SAM) used for Confocal Acoustic Microscopy (CAM), etc. When dealing with non-optical data storage media (e.g., magnetic tapes, hard drives, SSDs), a density scanning device may be used to measure the data distribution, signal strength, and/or material integrity of the data storage medium, which may be used as the physical characteristics 115.

In one embodiment, the data storage medium 105 may be an optical disc and the scanning may include performing a confocal acoustic microscopy (CAM) scan along a surface of the data storage medium 105 to detect physical characteristics/imperfections of the data storage medium. The physical imperfections are used as the physical characteristics 115 for generating a characteristics-based encryption key.

The output from a CAM scan of a surface is typically referred to as an acoustic image or acoustic micrograph. This may be a 2D or 3D image. The output image may represent the variations in acoustic impedance across the scanned surface, revealing structural details that are often invisible to optical imaging techniques and certainly invisible to the human eye. The obtained scan data is used as the physical characteristics 115 of the scanned region. The scanned physical characteristics 115 function as a unique fingerprint and/or signature of the scanned region and thus a unique fingerprint for the data storage medium 105.

With continued reference to FIG. 1, the physical characteristics 115 obtained from the scan are passed to a data converter 120. In one embodiment, the converter 120 is configured to convert the physical characteristics 115 of the data storage medium 105 into a string. The string may be text, numerical values, or a combination of both. In one embodiment, the string may be combined with a password. The string (or the string and password) is then input and used by an encryption key generator 125 to generate a characteristics-based encryption key 130 that is an encryption key created from the string that represents the physical characteristics 115 of the region scanned. For example, a deterministic hash function may be used. Other embodiments and details of the encryption key generator 125 are discussed below.

Once the characteristics-based encryption key 130 is generated, the encryption key 130 is used to encrypt the data content stored on the data storage medium 105. This creates a location relationship between the data storage medium 105 and the data contents stored thereon. In effect, the characteristics-based encryption key 130 is assigned to the specific data storage medium (e.g., a specific optical disc). If a cloud-based storage system includes multiple storage media (e.g., multiple optical discs), a unique characteristics-based encryption key 130 may be generated for each optical disc since each disc will have its own unique physical properties. In one embodiment, the entire contents of the data storage medium 105 may be encrypted.

The present data security technology lends itself well to a secure cloud storage service. Data may be encrypted at a client-side using the unique key derived from the assigned optical disc. The encrypted data is stored on the optical disc within a cloud provider's data center. To access the data, a user may provide their password, and the system initiates a re-scan of the same key-generation region to obtain the physical characteristics as previously performed. The system then regenerates an encryption/decryption key 130 from the specific disc's microscopic characteristics/imperfections obtained from the key-generation region. If the password is correct and if the storage medium is the same as the original, then decryption succeeds because the same encryption/decryption key was generated. If the data is stored on a different storage medium, decryption fails because different/incorrect encryption/decryption key was generated.

By intrinsically binding the encryption key to the physical disc, the present security technology improves prior security systems by eliminating the single point of failure associated with traditional key management systems. Even if a cloud provider's servers are compromised, the data remains inaccessible without the physical disc. Prior key management systems are also simplified by removing the complexities and overhead of generating, storing, rotating, and securing encryption keys separately. With the present system, the characteristics-based encryption/decryption keys do not need to be stored, rotated, or secured as in prior systems. Rather, each key may be regenerated on-demand by scanning the key-generating region of the physical disc as described herein. This simplifies the infrastructure of a cloud-based system. Thus, in general, by utilizing microscopic imperfections within a disc's resin layer as a source of entropy, the present novel technology eliminates the need for separate key storage and enhances data protection against breaches.

The present system also improves trust and data privacy. Users gain a higher level of trust knowing their data is inherently protected by a physical key embedded within the storage medium itself (e.g., its physical characteristics). This approach also strengthens compliance with data privacy regulations by minimizing the potential for unauthorized access.

Offline data protection is also improved. Even if a storage disc is removed from a cloud provider's infrastructure, the data remains secure. Decryption is impossible without the user's password and the specific physical disc. This feature is particularly beneficial for archival and cold storage systems.

The present system solves prior problems with the authentication of original data sources, multimedia access control and license verification, and may also be used for highly secure data storage.

### Encryption Method Embodiment

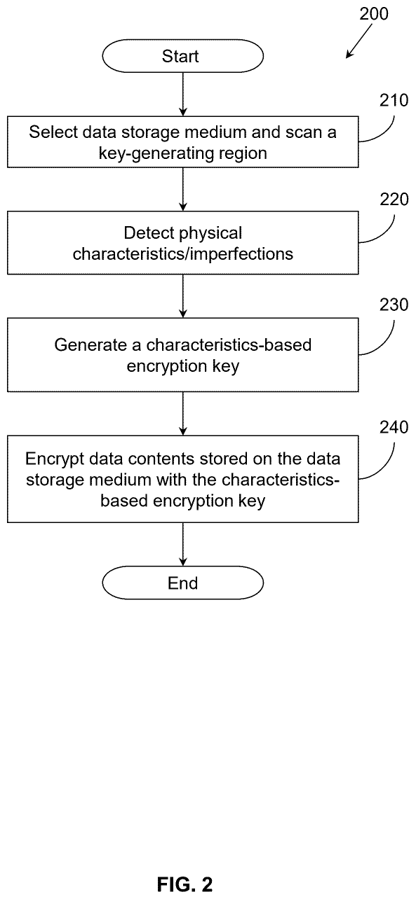

With reference to FIG. 2, one embodiment of a data security method 200 is illustrated that may be associated with the data security system 100 to encrypt data based on physical characteristics of a storage medium.

At block 210, a data storage medium is selected for encryption and a scan is performed on a selected target region on the data storage medium. As described previously, the selected target region functions as a key-generating region. The key-generating region may be defined as a specified default region or may be user defined. In one embodiment, the location of the key-generating region of a media may be self-disclosing in open headers, predetermined as an agreed standard, or access-controlled for high security applications.

In one embodiment, the location of the key-generating region may be selected from a non-writable area near a center of an optical disk. The scanning process may include selecting the scan region from the non-writable area near the center of the optical disk and scanning the non-writable area to detect physical characteristics of the non-writable area.

Deploying the scanning device as a read-write device creates an intrinsic and robust relationship between physical storage media and the data stored on it. The system controls the scanning device to scan the key-generating region.

At block 220, the scanning device scans and detects physical characteristics/imperfections (e.g., the entropy) of the key-generating region of the storage medium. Scan results are output in a format based on the type of scan. For example, in a Confocal Acoustic Microscopy (CAM) scan of a surface, various outputs may be obtained represented by various characteristics, such as but not limited to: (1) Acoustic Micrograph—A high-resolution grayscale or color image showing subsurface structures, defects, or material variations, (2) Time-of-Flight Data—Measures how long it takes for acoustic waves to bounce back from different depths, used to reconstruct 3D images, (3) C-Scan (2D Image of a Surface)—A top-down view showing variations in acoustic reflections, used for detecting delaminations, voids, and cracks, (4) B-Scan (Cross-Sectional Image)—A side-view slice through the material, useful for depth profiling, (5) A-Scan (Raw Echo Data)—A single-point signal showing the intensity of echoes over time, used for detailed analysis. Thus, the various outputs may include: acoustic micrographs (Images, e.g., PNG, TIFF format); numerical data (waveforms, echo amplitudes); time-of-flight (depth measurements); and/or reflection intensity values (acoustic impedance differences).

A conversion algorithm that is compatible with the type and format of the scan output may be used to convert the scan output into a string (text format) and/or numerical values. The converted scan output represents a string of features of the physical characteristics of scanned region from the particular storage medium.

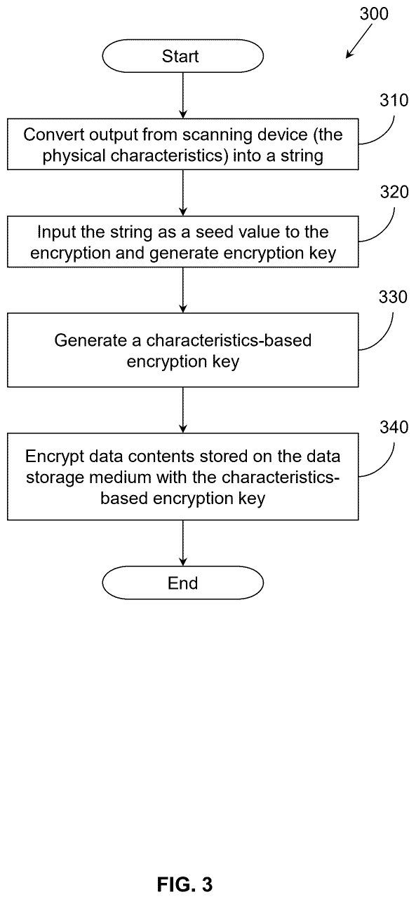

At block 230, a characteristics-based encryption key is generated that is an encryption key created from the physical characteristics of the region scanned. In one embodiment, a deterministic hash function or other type of encryption key generator may be used to generate an encryption key using the string format of the physical characteristics. In another embodiment, a salted password may be generated as the encryption key, which is described with reference to FIG. 3. There are multiple ways to create different types of encryption keys as long as the keys are generated based on the physical characteristics of the key-generating region that is scanned from the storage medium.

At block 240, a portion of contents or the entire contents of the data storage medium is encrypted with the characteristics-based encryption key that was generated. As stated previously, this present type of encryption creates a location relationship between the data storage medium and the data contents. By intrinsically binding the encryption key to the physical disc by using its own physical characteristics/imperfections, the present security technology improves prior security systems by eliminating the single point of failure associated with traditional key management systems.

### Salted Password-Encryption Key Embodiment

With reference to FIG. 3, one embodiment of a method 300 is illustrated that is associated with generating a characteristics-based encryption key from FIG. 2 in a format of a salted password. Method 300 is described from the point where the physical characteristics of the key-generating region have been obtained from scanning a specific data storage medium (e.g., a specific optical disc).

At block 310, the physical characteristics (scanning output) of the scanned region in the data storage medium are converted into a string format (e.g., text and/or numerical values). The string of characteristics serves as a key that represents the physical characteristics of the scanned key-generating region.

At block 320, the key (string of characteristics) is input as a seed value to a cryptographic random function, which generates a salt. A salt is a random string that may be added to a password to make it harder to decipher. To generate a salt, a seed value may be used, which is a starting point for randomness. The cryptographic random function turns the seed into a random salt. Using the same seed will always produce the same random result. Thus, by obtaining the same physical characteristics (as the key string of characteristics) by scanning the same key-generating region of a data storage medium, the same salt will be generated by the function. This allows for successful decryption. In one embodiment, the salt may be combined with a user password to generate the final characteristics-based encryption/decryption key.

At block 340, the data contents stored on the data storage medium are encrypted with the characteristics-based encryption key. This creates a location-based relationship between the data contents and the original data storage medium. With this location relationship, decrypting the data contents requires the same physical storage medium (e.g., the same specific optical disc).

Thus, data security system 100 is configured to successfully decrypt the data contents when the data contents are stored on the same data storage medium on which the data contents were encrypted. The data security system 100 will unsuccessfully decrypt the data contents when the data contents are stored on a second data storage medium that is different from the data storage medium on which the data contents were originally encrypted. Decryption will fail because the physical properties of the different data storage medium will generate an incorrect decryption key. Thus, two optical discs that are the same “type” of disc are still two different discs because they will have different physical characteristics/imperfections.

### Accessing the Data and Decryption Embodiment

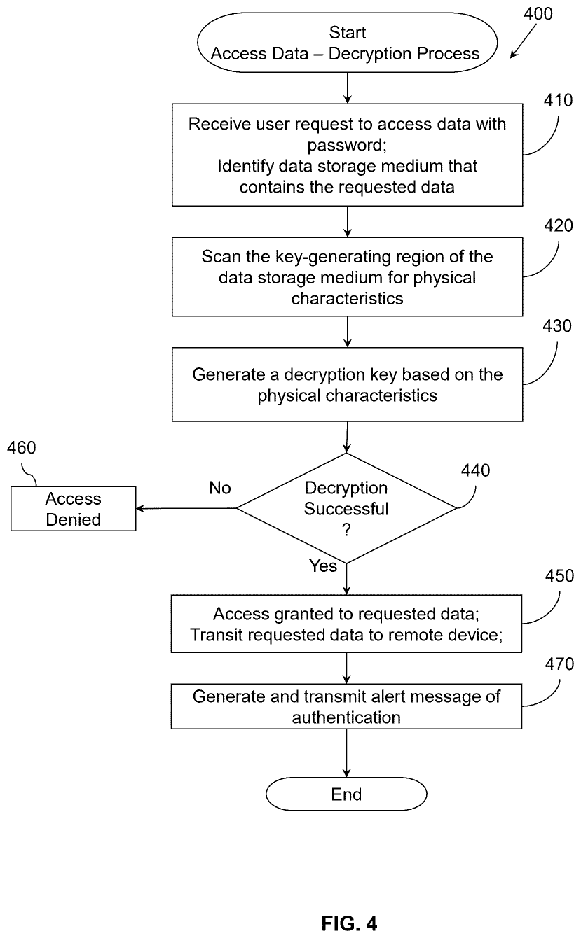

With reference to FIG. 4, one embodiment of a method 400 is illustrated that is associated with the data security system 100 (from FIG. 1) configured to control access to a storage medium that has been encrypted with the characteristics-based encryption key as previously described.

After the data content of the data storage medium is encrypted, user access and decryption are performed in a similar process to the encryption process. Decryption is similarly enabled by generating a decryption key on-demand by scanning the same key-generating region (symmetric) and/or different regions (asymmetric) to obtain the physical characteristics (e.g., entropy, imperfections, defects) from the storage medium, in one embodiment.

For example, at block 410, a request to access data may be received from a remote user device via network communications. In response to receiving the request, the system initiates an access protocol. This includes requesting a password from the user and identifying the specific physical storage medium that contains the requested data. The system also initiates key-generating steps to generate the characteristics-based encryption/decryption key on-demand as previously described.

At block 420, a scanning device is controlled to scan the physical storage medium at the same location of the key-generating region to detect and obtain the physical characteristics of the physical storage media.

At block 430, a decryption key is generated in the same manner that the characteristics-based encryption key was generated based on at least the scanned physical characteristics obtained in the previous step.

In one embodiment, key generation may include generating a salt where the system regenerates the salt from a seed, where the seed is the string representing the physical characteristics. The salt may be combined with the received user password to create the decryption key. The system may also hash the received user password with the salt again, if that was previously performed.

At block 440, the system 100 determines if decryption is successful. If decryption is successful, then at block 450, access to the data storage medium and to the requested target data is granted. The requested data may be transmitted to the remote device. If decryption fails, then at block 460, access is prohibited/denied. The system may generate and transmit an alert message with an error message that access is denied and the requested data contents cannot be provided.

In other words, if the data storage medium itself is the same original medium on which the data was encrypted, decryption will be successful because the scanned physical characteristics will be the same as the original. If the storage medium has changed (e.g., data has been moved or copied to a new medium) or if the media is damaged, decryption fails because the scanned physical characteristics will be different. Different physical characteristics will generate a different and incorrect encryption/decryption key.

Furthermore, the system may authenticate the data on the data storage medium based on whether the decryption key successfully decrypts the target data. If decryption is successful, then at block 470, the system 100 may generate and transmit an alert message that indicates data integrity and authentication. The data has been properly decrypted, which indicates that the data contents are stored on the same original storage source and is authentic.

### Cloud or Enterprise Embodiments

In one embodiment, the data security system 100 is a computing/data processing system including an application or collection of distributed applications for enterprise organizations. The applications and computing system 100 may be configured to operate with or be implemented as a cloud-based networking system, a software as a service (SaaS) architecture, or other type of networked computing solution. In one embodiment, the data security system 100 is a centralized server-side application that provides at least the functions disclosed herein and that is accessed by remote users via computing devices/terminals communicating with the computing system 100 (functioning as the server) over a computer network/network communications.

In one embodiment, one or more of the components described herein are configured as program modules stored in a non-transitory computer readable medium. The program modules are configured with stored instructions that when executed by at least a processor of a computing system cause the computing system to perform the corresponding function(s) as described herein.

### Computing Device/System Embodiment

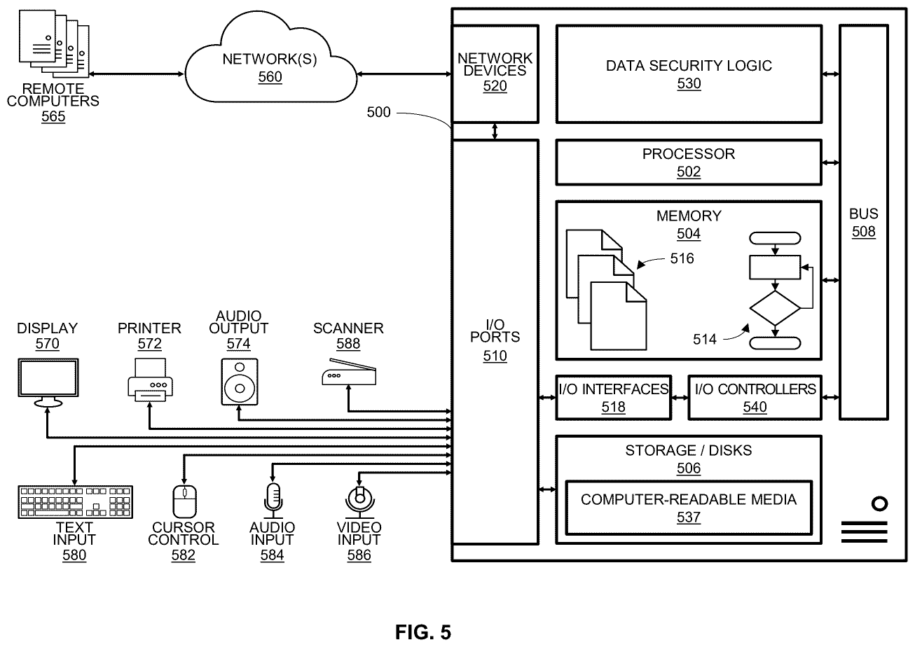

FIG. 5 illustrates an example computing device/system that is configured and/or programmed as a special purpose computing device with one or more of the example systems and methods described herein, and/or equivalents. The example computing device may be a computer 500 that includes at least one hardware processor 502, a memory 504, and input/output ports 510 operably connected by a bus 508. In one example, the computer 500 may include data security logic 530 configured to facilitate data security and encryption similar to data security system 100 shown in FIGS. 1-4.

In different examples, the logic 530 may be implemented in hardware, a non-transitory computer-readable medium 537 with stored instructions, firmware, and/or combinations thereof. While the logic 530 is illustrated as a hardware component attached to the bus 508, it is to be appreciated that in other embodiments, the logic 530 could be implemented in the processor 502, stored in memory 504, or stored in disk 506.

In one embodiment, logic 530 or the computer is a means (e.g., structure: hardware, non-transitory computer-readable medium, firmware) for performing the actions described. In some embodiments, the computing device may be a server operating in a cloud computing system, a server configured in a Software as a Service (SaaS) architecture, a smart phone, laptop, tablet computing device, and so on.

The means may be implemented, for example, as an ASIC programmed to provide data encryption based on physical characteristics of a data storage medium. The means may also be implemented as stored computer executable instructions that are presented to computer 500 as data 516 that are temporarily stored in memory 504 and then executed by processor 502.

Logic 530 may also provide means (e.g., hardware, non-transitory computer-readable medium that stores executable instructions, firmware) for performing one or more of the disclosed functions and/or combinations of the functions.

Generally describing an example configuration of the computer 500, the processor 502 may be a variety of various processors including dual microprocessor and other multi-processor architectures. A memory 504 may include volatile memory and/or non-volatile memory. Non-volatile memory may include, for example, ROM, PROM, and so on. Volatile memory may include, for example, RAM, SRAM, DRAM, and so on.

A storage disk 506 may be operably connected to the computer 500 via, for example, an input/output (I/O) interface (e.g., card, device) 518 and an input/output port 510 that are controlled by at least an input/output (I/O) controller 540. The disk 506 may be, for example, a magnetic disk drive, a solid state disk drive, a floppy disk drive, a tape drive, a Zip drive, a flash memory card, a memory stick, and so on. Furthermore, the disk 506 may be a CD-ROM drive, a CD-R drive, a CD-RW drive, a DVD ROM, and so on. The memory 504 can store a process 514 and/or a data 516, for example. The disk 506 and/or the memory 504 can store an operating system that controls and allocates resources of the computer 500.

The computer 500 may interact with, control, and/or be controlled by input/output (I/O) devices via the input/output (I/O) controller 540, the I/O interfaces 518, and the input/output ports 510. Input/output devices may include, for example, one or more displays 570, printers 572 (such as inkjet, laser, or 3D printers), audio output devices 574 (such as speakers or headphones), text input devices 580 (such as keyboards), cursor control devices 582 for pointing and selection inputs (such as mice, trackballs, touch screens, joysticks, pointing sticks, electronic styluses, electronic pen tablets), audio input devices 584 (such as microphones or external audio players), video input devices 586 (such as video and still cameras, or external video players), image scanners 588, video cards (not shown), disks 506, network devices 520, and so on. The input/output ports 510 may include, for example, serial ports, parallel ports, and USB ports.

The computer 500 can operate in a network environment and thus may be connected to the network devices 520 via the I/O interfaces 518, and/or the I/O ports 510. Through the network devices 520, the computer 500 may interact with a network 560. Through the network, the computer 500 may be logically connected to remote computers 565. Networks with which the computer 500 may interact include, but are not limited to, a LAN, a WAN, and other networks.

### Definitions and Other Embodiments

In another embodiment, the described methods and/or their equivalents may be implemented with computer executable instructions. Thus, in one embodiment, a non-transitory computer readable/storage medium is configured with stored computer executable instructions of an algorithm/executable application that when executed by a machine(s) cause the machine(s) (and/or associated components) to perform the method. Example machines include but are not limited to a processor, a computer, a server operating in a cloud computing system, a server configured in a Software as a Service (SaaS) architecture, a smart phone, and so on). In one embodiment, a computing device is implemented with one or more executable algorithms that are configured to perform any of the disclosed methods.

In one or more embodiments, the disclosed methods or their equivalents are performed by either: computer hardware configured to perform the method; or computer instructions embodied in a module stored in a non-transitory computer-readable medium where the instructions are configured as an executable algorithm configured to perform the method when executed by at least a processor of a computing device.

While for purposes of simplicity of explanation, the illustrated methodologies in the figures are shown and described as a series of blocks of an algorithm, it is to be appreciated that the methodologies are not limited by the order of the blocks. Some blocks can occur in different orders and/or concurrently with other blocks from that shown and described. Moreover, less than all the illustrated blocks may be used to implement an example methodology. Blocks may be combined or separated into multiple actions/components. Furthermore, additional and/or alternative methodologies can employ additional actions that are not illustrated in blocks.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

A “data structure”, as used herein, is an organization of data in a computing system that is stored in a memory, a storage device, or other computerized system. A data structure may be any one of, for example, a data field, a data file, a data array, a data record, a database, a data table, a graph, a tree, a linked list, and so on. A data structure may be formed from and contain many other data structures (e.g., a database includes many data records). Other examples of data structures are possible as well, in accordance with other embodiments.

“Computer-readable medium” or “computer storage medium”, as used herein, refers to a non-transitory medium that stores instructions and/or data configured to perform one or more of the disclosed functions when executed. Data may function as instructions in some embodiments. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an application specific integrated circuit (ASIC), a programmable logic device, a compact disk (CD), other optical medium, a random access memory (RAM), a read only memory (ROM), a memory chip or card, a memory stick, solid state storage device (SSD), flash drive, and other media from which a computer, a processor or other electronic device can function with. Each type of media, if selected for implementation in one embodiment, may include stored instructions of an algorithm configured to perform one or more of the disclosed and/or claimed functions.

“Logic”, as used herein, represents a component that is implemented with computer or electrical hardware, a non-transitory medium with stored instructions of an executable application or program module, and/or combinations of these to perform any of the functions or actions as disclosed herein, and/or to cause a function or action from another logic, method, and/or system to be performed as disclosed herein. Equivalent logic may include firmware, a microprocessor programmed with an algorithm, a discrete logic (e.g., ASIC), at least one circuit, an analog circuit, a digital circuit, a programmed logic device, a memory device containing instructions of an algorithm, and so on, any of which may be configured to perform one or more of the disclosed functions. In one embodiment, logic may include one or more gates, combinations of gates, or other circuit components configured to perform one or more of the disclosed functions. Where multiple logics are described, it may be possible to incorporate the multiple logics into one logic. Similarly, where a single logic is described, it may be possible to distribute that single logic between multiple logics. In one embodiment, one or more of these logics are corresponding structure associated with performing the disclosed and/or claimed functions. Choice of which type of logic to implement may be based on desired system conditions or specifications. For example, if greater speed is a consideration, then hardware would be selected to implement functions. If a lower cost is a consideration, then stored instructions/executable application would be selected to implement the functions.

An “operable connection”, or a connection by which entities are “operably connected”, is one in which one or more communication channels are established (or may be established upon request) that allow signals, data, messages, physical communications, and/or logical communications to be sent and/or received between the entities. An operable connection may include a physical interface, an electrical interface, and/or a data interface with one or more transmitters and receivers that communicate with wired and/or wireless signals. An operable connection may include differing combinations of interfaces and/or connections sufficient to establish and allow communication. For example, two entities can be operably connected to communicate signals to each other directly or through one or more intermediate entities (e.g., processor, operating system, logic, non-transitory computer-readable medium, internet communication devices, local network, etc.). Logical and/or physical communication channels can be used to create an operable connection.

“User”, as used herein, includes but is not limited to one or more persons, computers or other devices, or combinations of these.

While the disclosed embodiments have been illustrated and described in considerable detail, it is not the intention to restrict or in any way limit the scope of the appended claims to such detail. It is, of course, not possible to describe every conceivable combination of components or methodologies for purposes of describing the various aspects of the subject matter. Therefore, the disclosure is not limited to the specific details or the illustrative examples shown and described.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When intended to indicate “only A or B but not both” then the phrase “only A or B but not both” will be used. Thus, use of the term “or” herein is the inclusive, and not the exclusive use.

What is claimed is:

1. A method performed by a computing device, the method comprising:
scanning a region of a data storage medium to detect physical characteristics of the region in the data storage medium;
generating a characteristics-based encryption key based on at least the physical characteristics of the data storage medium; and
encrypting data contents stored on the data storage medium with the characteristics-based encryption key to create a location relationship between the data storage medium and the data contents.

2. The method of claim 1, wherein the scanning includes performing a confocal acoustic microscopy scan along a surface of the data storage medium to detect physical imperfections of the data storage medium; and
wherein the physical imperfections are used as the physical characteristics for generating the characteristics-based encryption key.

3. The method of claim 1, wherein the scanning includes a density scan of the data storage medium to detect the physical characteristics of the region.

4. The method of claim 1, further comprising:
converting the physical characteristics of the data storage medium into a string; and
wherein the characteristics-based encryption key is generated from the string.

5. The method of claim 1, further comprising:
converting the physical characteristics of the region in the data storage medium into a string, wherein the string serves as a key that represents the physical characteristics;
inputting the key as a seed value to a cryptographic random function and generating a salt; and
combining the salt with a password to generate the characteristics-based encryption key.

6. The method of claim 1, wherein the data storage medium includes an optical disk; and
wherein the scanning includes selecting the region from a non-writable area near a center of the optical disk and scanning the non-writable area to detect physical characteristics of the non-writable area.

7. The method of claim 1, further comprising:
in response to receiving a request to access a target data on the data storage medium, scanning the region of the data storage media to detect the physical characteristics of the data storage media;
generating a decryption key in the manner that the characteristics-based encryption key was generated based on at least the physical characteristics of the physical storage media; and
authenticating the target data based on whether the decryption key successfully decrypts the target data.

8. A non-transitory computer-readable medium that includes stored thereon computer-executable instructions that when executed by at least a processor of a computing system, wherein the computing system includes one or more computing devices, cause the computing system to:
control a scanning device to scan a region of a data storage medium to detect physical characteristics of the region in the data storage medium;
wherein the data storage medium is an original storage source for a set of data content;
generate a characteristics-based encryption key that is an encryption key created from the physical characteristics of the region scanned; and
encrypt the set of data content stored on the data storage medium with the characteristics-based encryption key to create a location relationship between the data storage medium and the data contents.

9. The non-transitory computer-readable medium of claim 8, wherein the scan includes performing a confocal acoustic microscopy scan or a density scan along a surface of the data storage medium to detect physical imperfections of the data storage medium; and
wherein the physical imperfections are used as the physical characteristics for generating the characteristics-based encryption key.

10. The non-transitory computer-readable medium of claim 8, further comprising instructions that when executed by at least the processor cause the processor to:
convert the physical characteristics of the data storage medium into a string; and
wherein the characteristics-based encryption key is generated from the string.

11. The non-transitory computer-readable medium of claim 8, further comprising instructions that when executed by at least the processor cause the processor to:
convert the physical characteristics of the region in the data storage medium into a string, wherein the string serves as a key that represents the physical characteristics;
input the key as a seed value to a cryptographic random function and generate a salt; and
combine the salt with a password to generate the characteristics-based encryption key.

12. The non-transitory computer-readable medium of claim 8, wherein the data storage medium includes an optical disk; and
wherein controlling the scan includes selecting the region from a non-writable area near a center of the optical disk and scanning the non-writable area to detect physical characteristics of the non-writable area.

13. The non-transitory computer-readable medium of claim 8, further comprising instructions that when executed by at least the processor, cause the processor to:
in response to receiving a request to access a target data on the data storage medium, scan the region of the data storage media to detect the physical characteristics of the data storage media;
generate a decryption key in the manner that the characteristics-based encryption key was generated based on at least the physical characteristics of the data storage media; and
authenticate the target data based on whether the decryption key successfully decrypts the target data.

14. A computing system, comprising:
one or more computing devices operably connected to communicate over one or more communication networks via one or more network interfaces;
at least one processor connected to at least one memory, wherein the at least one processor is operably connected to at least one of the one or more computing devices; and
a non-transitory computer readable medium including instructions stored thereon that when executed by at least the processor cause the computing system to:
scan a region of a data storage medium to detect physical characteristics of the region in the data storage medium;
generate a characteristics-based encryption key based on at least the physical characteristics of the physical storage medium; and
encrypt data contents stored on the data storage medium with the characteristics-based encryption key.

15. The computing system of claim 14, wherein the scan includes controlling a scanning device to perform a confocal acoustic microscopy scan or a density scan along a surface of the data storage medium to detect physical imperfections of the data storage medium; and
wherein the physical imperfections are used as the physical characteristics for generating the characteristics-based encryption key.

16. The computing system of claim 14, wherein the computing system is further configured to:
convert the physical characteristics of the data storage medium into a string; and
wherein the characteristics-based encryption key is generated from the string.

17. The computing system of claim 14, wherein the computing system is further configured to:
convert the physical characteristics of the region in the data storage medium into a string, wherein the string serves as a key that represents the physical characteristics;
input the key as a seed value to a cryptographic random function and generate a salt; and
combine the salt with a password to generate the characteristics-based encryption key.

18. The computing system of claim 14, wherein the data storage medium includes an optical disk; and
wherein the scan includes selecting the region from a non-writable area near a center of the optical disk and scanning the non-writable area to detect physical characteristics of the non-writable area.

19. The computing system of claim 14, wherein the computing system is configured to:
successfully decrypt the data contents when the data contents are stored on the data storage medium on which the data contents were encrypted; and
unsuccessfully decrypt the data contents when the data contents are stored on a second data storage medium that is different from the data storage medium on which the data contents were encrypted.

20. The computing system of claim 14, wherein the computing system is further configured to:
in response to receiving a request to access data on the physical storage medium, scan the region of the data storage media to detect the physical characteristics of the data storage media;
generate a decryption key in the manner that the characteristics-based encryption key was generated based on at least the physical characteristics of the data storage media; and
validate the target data based on whether the decryption key successfully decrypts the target data.
